(19) United States
(12) Patent Application Publication
(10) Pub. No.: US 2011/0141055 A1
(43) Pub. Date: Jun. 16, 2011

(54) Projected Capacitive Touch Panel

(75) Inventor: Jane Hsu, Guishan Township (TW)

(73) Assignee: MINLEAD LTD., Taipei City (TW)

(21) Appl. No.: 12/785,686

(22) Filed: May 24, 2010

(30) Foreign Application Priority Data
Dec. 11, 2009 (TW) 098223215

(51) Int. Cl. G06F 3/044

(52) U.S. Cl. 345/174; 178/18.06

(57) ABSTRACT

A projected capacitive touch panel has a lower substrate, an upper substrate and an insulating adhesive layer. The lower substrate has a first-axial conductive area. The first-axial conductive area has multiple conductive strips arranged in parallel in a first axis. The upper substrate has a second-axial conductive area. The second-axial conductive area has multiple conductive strips arranged in parallel in a second axis different from the first axis. The insulating adhesive layer formed between the lower substrate and the upper substrate to adhere the lower substrate and the upper substrate. Two substrates respectively have conductive areas with different axes, so avoid formation of apexes and keep the substrates flat. Therefore, incident light of the projected capacitive touch panel is able to reflect evenly and avoid interference. The projected capacitive touch panel has stable quality and saves costs because no damage occurs during transportation.

### BACKGROUND OF THE INVENTION

1. Field of Invention

The present invention relates to a projected capacitive touch panel, and more particularly to a projected capacitive touch panel with two substrates to avoid apexes caused at intersections of two conductive areas of different axes causing light interference and to prevent the apexes causing cracking due to the environmental change, so prolonging lifetime of the projected capacitive touch panel during normal operation.

2. Description of the Related Art

Conventional touch panels include resistive touch panels, capacitive touch panels, acoustic wave touch panels and optical touch panels. Recently, capacitive touch panels have become more popular after Apple Computer, Inc. released iPod series and iPhone.

Capacitive touch panels can be grouped into surface resistive touch panels (single-touch) and projected capacitive touch panel (multi-touch) and projected capacitive touch panel that was used in the iPod series and iPhone. Projected capacitive touch panels are able to detect multiple touches simultaneously to enlarge, narrow, rotate or drag a pattern on a projected capacitive touch panel, which is convenient for users. Projected capacitive touch panels overcame disadvantages in resistive touch panels to avoid wearing out the resistive touch panels.

Axis intersection type is a common type of projected capacitive touch panels. With reference to FIGS. 4 and 5, a conventional projected capacitive touch panel with two intersecting axes has a substrate (40) and a protective layer (50). The substrate (40) has a vertical axial conductive area (41a) and a horizontal axial conductive area (41b). The vertical axial conductive area (41a) and the horizontal axial conductive area (41b) intersect. Each axial conductive area (41a, 41b) has multiple ITO conductive strips and each ITO conductive strip has two ends, one port (411a, 411b), multiple rhombus ITO dots (412a, 412b) and multiple connecting wires (413a, 413b). The port (411a, 411b) is formed on one of the ends to connect with soft cable by a conductive wire (42) for connecting the projected capacitive touch panel electrically to a PCB.

Each connecting wire (413a, 413b) connects two ITO dots (412a, 412b). However, when the vertical axial conductive area (41a) and the horizontal axial conductive area (41b) is intersected, the connecting wire (413a, 413b) of one conductive area (41a, 41b) has to cross the connecting wire (413a, 413b) of anther conductive area (41a, 41b). As shown in FIGS. 4 and 5, the connecting wire (413b) of the horizontal conductive area (41b) crosses the connecting wire (413a) of the vertical conductive area (41a). Therefore, the connecting wire (413b) of the horizontal conductive area (41b) is bent to form a apex.

Since a touch panel screen is transparent, the apexes may change light direction. Furthermore, the apexes may break when pressure and temperature are increased during transportation. Therefore, the conventional projected capacitive touch panel cannot be used under desired conditions.

To overcome the shortcomings, the present invention provides a projected capacitive touch panel to mitigate or obviate the aforementioned.

### SUMMARY OF THE INVENTION

The primary objective of the present invention is to provide a projected capacitive touch panel with two substrates to avoid apexes caused at intersections of two conductive areas of different axes causing light interference and to prevent the apexes causing cracking due to environmental change, so prolonging lifetime of the projected capacitive touch panel in normal operation. To achieve the objective, the projected capacitive touch panel in accordance with the present invention comprises a lower substrate, an upper substrate and an insulating adhesive layer. The lower substrate has a first-axial conductive area. The first-axial conductive area has multiple conductive strips arranged in parallel in a first axis. The upper substrate has a second-axial conductive area. The second-axial conductive area has multiple conductive strips arranged in parallel in a second axis different from the first axis. The insulating adhesive layer is formed between the lower substrate and the upper substrate to adhere the lower substrate to the upper substrate.

Two substrates respectively have conductive areas with different axes, to avoid apexes forming and keep the substrates flat. Therefore, incident light of the projected capacitive touch panel is reflected evenly to avoid interference. The projected capacitive touch panel has stable quality and saves cost because no damage occurs during transportation.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an upper substrate and a lower substrate of a projected capacitive touch panel in accordance with the present invention;

FIG. 2 is a cross sectional side view of a projected capacitive touch panel in accordance with the present invention;

FIG. 3 is a top view of the projected capacitive touch panel in FIG. 2; and

FIG. 4 is a perspective view of a conventional projected capacitive touch panel in accordance with the prior art; and

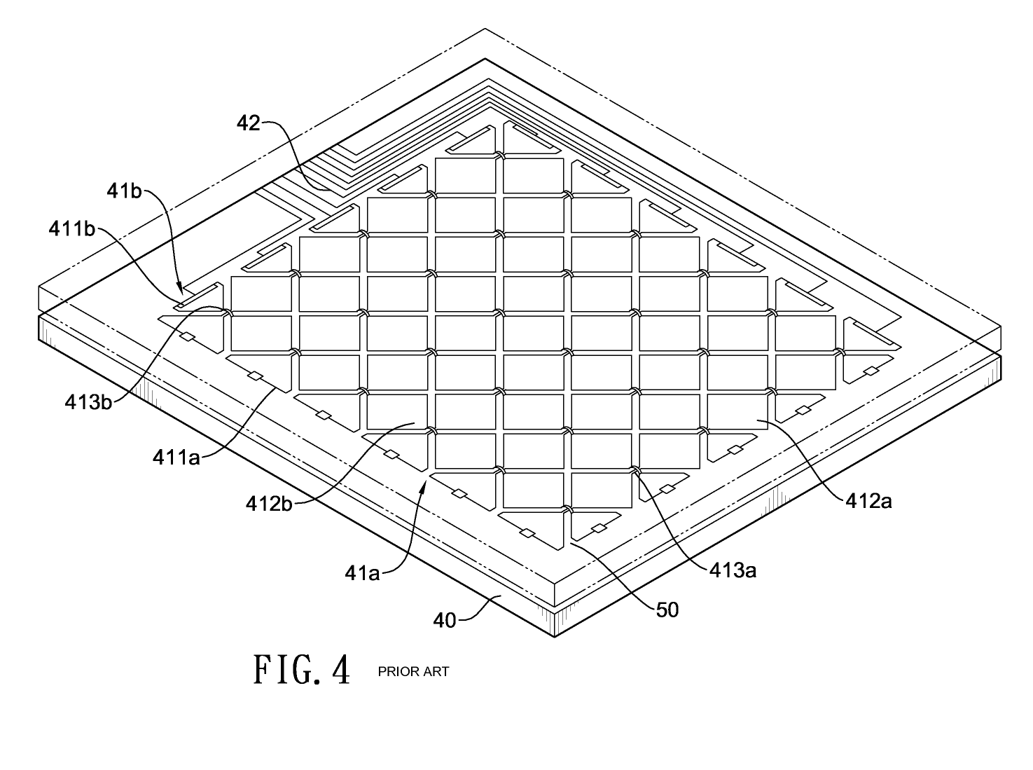

FIG. 5 is a top view of the conventional projected capacitive touch panel in FIG. 4.

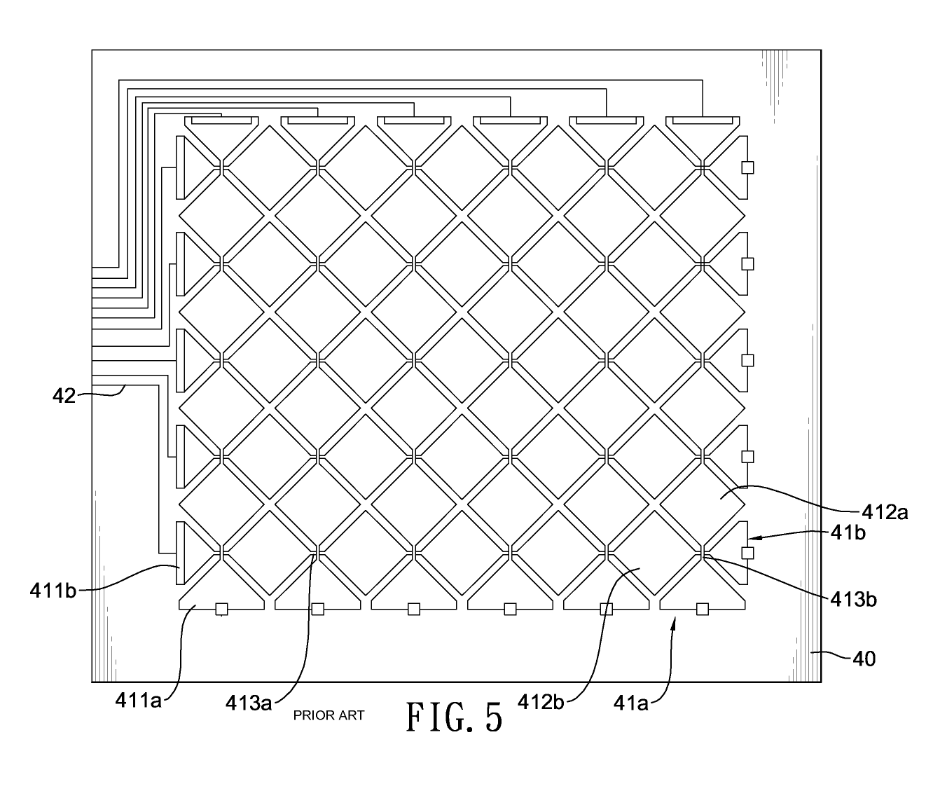

### DETAILED DESCRIPTION OF THE INVENTION

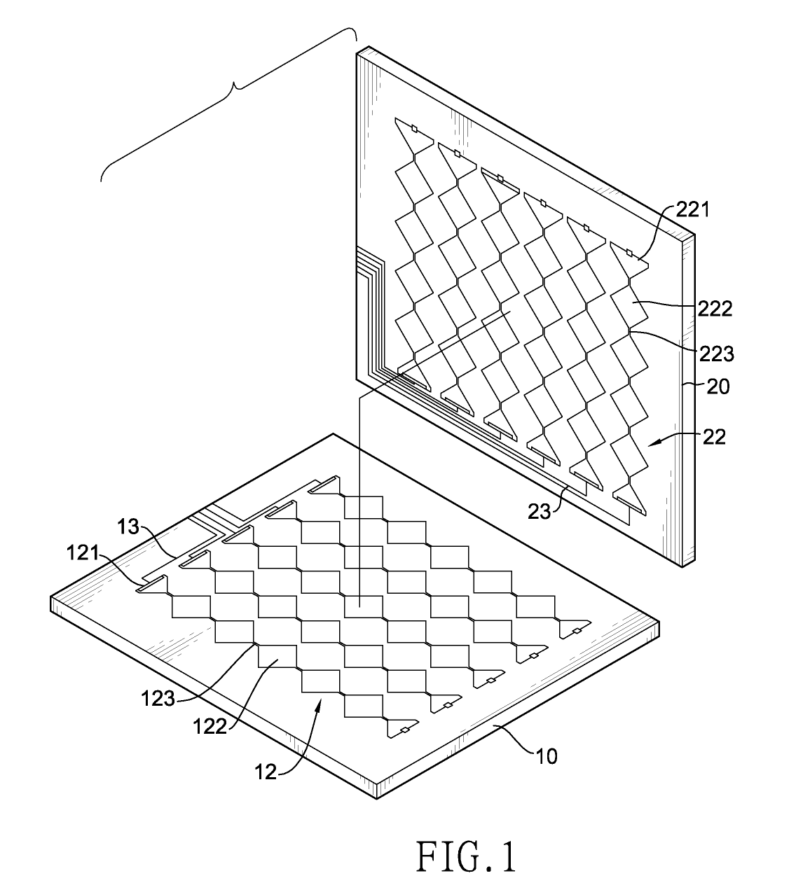

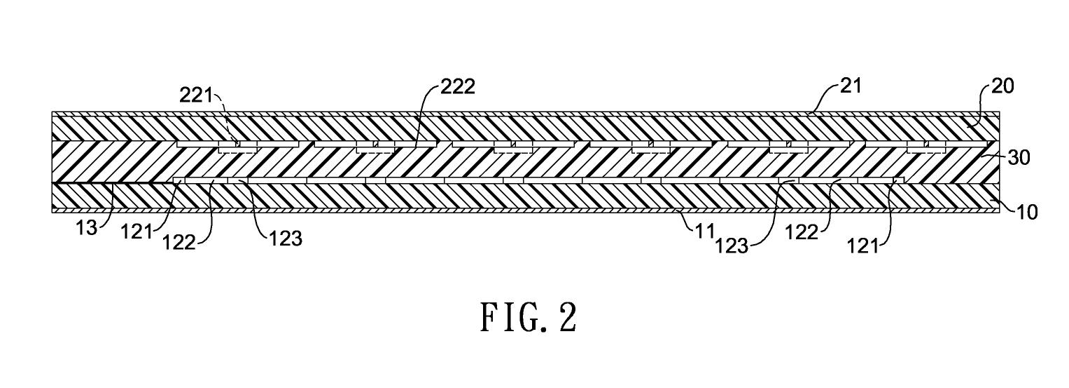

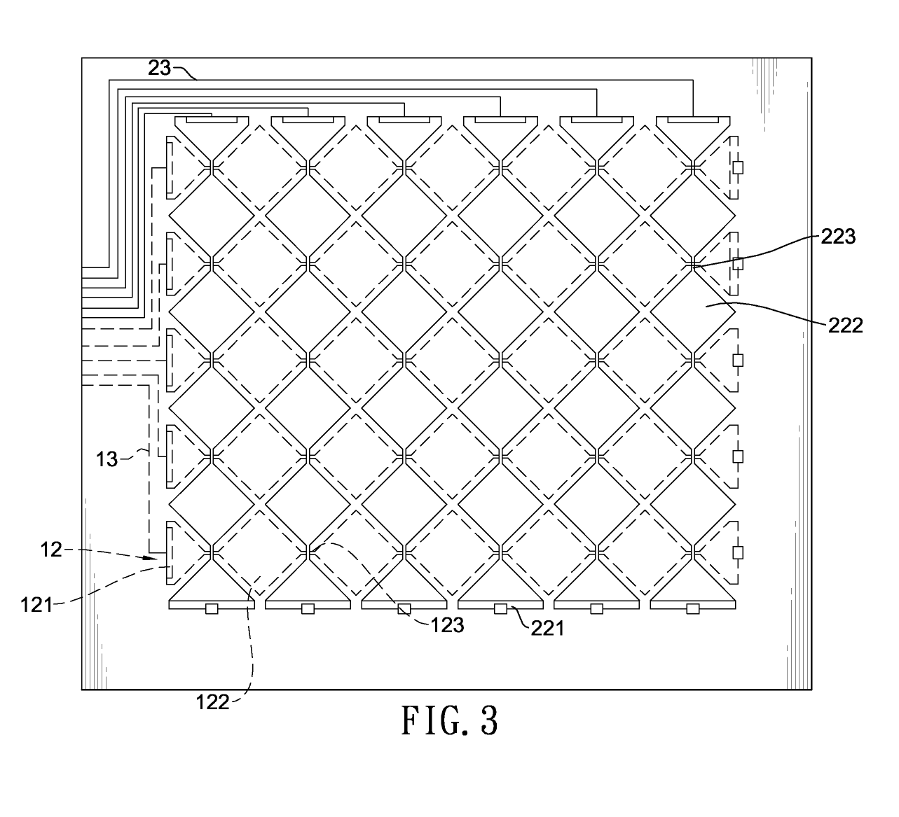

With reference to FIGS. 1, 2 and 3, a projected capacitive touch panel in accordance with the present invention has a lower substrate (10), an anti-electromagnetic interference (EMI) layer (11), an upper substrate (20), a protective layer (21) and an insulating adhesive layer (30).

The lower substrate (10) has an upper surface, a lower surface, a first-axial conductive area (12) and multiple conductive wires (13). The first-axial conductive area (12) is formed on the upper surface of the lower substrate (10) and has multiple conductive strips. The conductive strips are arranged in parallel in a first axis and each conductive strip has two ends, one port (121), multiple dots (122) and multiple connecting wires (123). The port (121) is formed on one of the ends of the conductive strip. The dots (122) may be made of indium tin oxide (ITO). Each connecting wire (123) is formed between two dots (122) and connects the dots (122) and may be made of ITO. The conductive wires (13) connect respectively corresponding ports (121) and may be made of conductive material that preferably is silver.

The anti-EMI layer (11) is formed on the lower surface of the lower substrate (10) and may be made of ITO.

The upper substrate (20) has an upper surface, a lower surface, a second-axial conductive area (22) and multiple conductive wires (23). The second-axial conductive area (22) is formed on the lower surface of the upper substrate (20) and has multiple conductive strips. The conductive strips are arranged in a second axis different from the first axis and in parallel and each conductive strip has two ends, one port (221), multiple dots (222) and multiple connecting wires (223). The port (221) is formed on one of the ends of the conductive strip. The dots (222) are located on the upper substrate (20) corresponding to locations without the first-axial conductive area (12) and the dots (222) may be made of indium tin oxide (ITO). Each connecting wire (223) is formed between two dots (222) and connects the dots (222) and may be made of ITO. The conductive wires (23) connect respectively to corresponding ports (221) and may be made of conductive material, preferably the conductive material is silver.

The protective layer (21) is formed on the upper surface of the upper substrate (20).

The insulating adhesive layer (30) is formed between the lower substrate (10) and the upper substrate (20) to adhere the lower substrate (10) to the upper substrate (20) and may be made of insulating adhesives.

The present invention uses two substrates respectively having conductive areas with different axes, so avoids formation of apexes and keeps the substrates flat. Therefore, incident light of the projected capacitive touch panel is able to reflect evenly and avoid interference. The projected capacitive touch panel of the present invention is stable and saves costs because no damage occurs during transportation.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A projected capacitive touch panel comprising:
a lower substrate having
an upper surface;
a lower surface; and
a first-axial conductive area formed on the upper surface of the lower substrate and having multiple conductive strips arranged in a first axis and in parallel and each conductive strip having
multiple dots; and
multiple connecting wires and each formed between two dots and connecting the dots;
an anti-electromagnetic interference (EMI) layer formed on the lower surface of the lower substrate;
an upper substrate having
an upper surface;
a lower surface;
a second-axial conductive area formed on the lower surface of the upper substrate and having multiple conductive strips arranged in a second axis different from the first axis and in parallel and each conductive strip having
multiple dots located on the upper substrate corresponding to locations without the first-axial conductive area; and
multiple connecting wires and each formed between two dots and connecting the dots; and
an insulating adhesive layer formed between the lower substrate and the upper substrate to adhere the lower substrate and the upper substrate.

2. The projected capacitive touch panel as claimed in claim 1, wherein
the lower substrate further has multiple conductive wires; and each conductive strip of the lower substrate further has
two ends; and
one port formed on one of the ends of the conductive strip and respectively connecting the conductive wires; and
the upper substrate further has multiple conductive wires; and each conductive strip of the upper substrate further has
two ends; and
one port formed on one of the ends of the conductive strip and respectively connecting the conductive wires.

3. The projected capacitive touch panel as claimed in claim 2, wherein
each conductive wire of the lower substrate is made of conductive material; and
each conductive wire of the upper substrate is made of conductive material.

4. The projected capacitive touch panel as claimed in claim 3, wherein
each conductive wire of the lower substrate is made of silver; and
each conductive wire of the upper substrate is made of silver.

5. The projected capacitive touch panel as claimed in claim 1, further having a protective layer formed on the upper surface of the upper substrate.

6. The projected capacitive touch panel as claimed in claim 2, further having a protective layer formed on the upper surface of the upper substrate.

7. The projected capacitive touch panel as claimed in claim 3, further having a protective layer formed on the upper surface of the upper substrate.

8. The projected capacitive touch panel as claimed in claim 4, further having a protective layer formed on the upper surface of the upper substrate.

9. The projected capacitive touch panel as claimed in claim 1, wherein the anti-EMI layer is made of indium tin oxide (ITO).

10. The projected capacitive touch panel as claimed in claim 2, wherein the anti-EMI layer is made of ITO.

11. The projected capacitive touch panel as claimed in claim 3, wherein the anti-EMI layer is made of ITO.

12. The projected capacitive touch panel as claimed in claim 4, wherein the anti-EMI layer is made of ITO.

13. The projected capacitive touch panel as claimed in claim 8, wherein the anti-EMI layer is made of ITO.

14. The projected capacitive touch panel as claimed in claim 1, wherein
each dot and each connecting wire of the lower substrate is made of ITO; and
each dot and each connecting wire of the upper substrate is made of ITO.

15. The projected capacitive touch panel as claimed in claim 2, wherein
each dot and each connecting wire of the lower substrate is made of ITO; and
each dot and each connecting wire of the upper substrate is made of ITO.

16. The projected capacitive touch panel as claimed in claim 3, wherein
each dot and each connecting wire of the lower substrate is made of ITO; and
each dot and each connecting wire of the upper substrate is made of ITO.

17. The projected capacitive touch panel as claimed in claim 4, wherein
each dot and each connecting wire of the lower substrate is made of ITO; and
each dot and each connecting wire of the upper substrate is made of ITO.

18. The projected capacitive touch panel as claimed in claim 8, wherein
each dot and each connecting wire of the lower substrate is made of ITO; and
each dot and each connecting wire of the upper substrate is made of ITO.

19. The projected capacitive touch panel as claimed in claim 13, wherein
each dot and each connecting wire of the lower substrate is made of ITO; and
each dot and each connecting wire of the upper substrate is made of ITO.
